(19) United States
(12) Patent Application Publication
(10) Pub. No.: US 2010/0148923 A1
(43) Pub. Date: Jun. 17, 2010

(54) VEHICLE ON-BOARD BIOMETRIC AUTHENTICATION SYSTEM

(75) Inventor: Ryo Takizawa, Toyota-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/640,704

(22) Filed: Dec. 17, 2009

(30) Foreign Application Priority Data
Dec. 17, 2008 (JP) JP2008-321112

(51) Int. Cl. G06F 7/04

(52) U.S. Cl. 340/5.82

(57) ABSTRACT

A vehicular biometric authentication system is equipped with a portable terminal that includes a receiver that receives authentication data output from a data management center, and an on-board device that acquires the authentication data via the portable terminal and uses the acquired authentication data to carry out identity verification when communication with the management center is impossible. When a vehicle is stopped outside the communication range of the data management center, the on-board device acquires via the portable terminal the authentication data output from the data management center. Thus, the on-board device utilizes the authentication data acquired via the portable terminal to carry out identity verification.

### INCORPORATION BY REFERENCE

The disclosure of Japanese Patent Application No. 2008-321112 filed on Dec. 17, 2008 including the specification, drawings and abstract is incorporated herein by reference in its entirety.

### BACKGROUND OF THE INVENTION

1. Field of the Invention

The invention relates to a vehicular biometric authentication system.

2. Description of the Related Art

Conventionally, biometric data is registered with a management center (an authentication server) and then collated with biometric information obtained from a user (a person to be authenticated) to verify the identity of the individual and then unlock a door lock (e.g., Japanese Patent Application Publication No. 2005-36523 (JP-A-2005-36523)).

In a configuration in which the biometric data is downloaded from the management center to a vehicle (an on-vehicle device) when verifying an individual's identity, the authentication biometric data cannot be downloaded from the management center to the on-vehicle device if the vehicle is stopped outside the communication range of the management center. Therefore, biometric authentication cannot be carried out.

### SUMMARY OF THE INVENTION

The invention provides a vehicular biometric authentication system capable of carrying out biometric authentication even when a vehicle is stopped outside a range of communication with a management center.

According to one aspect of the invention, a vehicular biometric authentication system is provided that compares biometric data registered with a data management center with biometric information obtained from a person to be authenticated to verify the individual's identity. The vehicular biometric authentication system includes a portable terminal equipped with a receiver that receives the stored biometric data from the management center, and an on-vehicle device that acquires the biometric data from the data management center or via the portable terminal and uses the acquired biometric data to verify the person's identity. The on-board device may acquire the biometric data via the portable terminal and uses the acquired biometric data to verify the person's identity when the portable terminal moves during stoppage of a vehicle.

The vehicle on-board biometric authentication system described above is equipped with the portable terminal equipped with the reception device for receiving the biometric data output from the data management center, and the on-board device that acquires the authentication data via the portable terminal and uses the acquired authentication data to verify identity when the portable terminal moves during stoppage of the vehicle. Therefore, the authentication data output from the management center may be acquired via the portable terminal. Thus, the on-board device uses the authentication data acquired via the portable terminal to carry out identity verification. That is, regardless of whether or not communication between the on-vehicle machine and the management center is impossible, the authentication data acquired via the portable terminal can be utilized to carry out identity verification.

Further, it is preferable that the on-board device acquires the authentication data via the portable terminal and use the acquired authentication data to carry out identity verification when communication between the on-vehicle machine and the management center is impossible. Thus, if the vehicle is stopped in an area where communication with the management center is impossible and the portable terminal can move into a communication range (when the portable terminal moves to an area outside the vehicle), the authentication data acquired via the portable terminal may be utilized to carry out identity verification. Furthermore, the acquired biometric data may be deleted from the on-board device after a predetermined period of time has elapsed.

According to the vehicle on-board biometric authentication system of the invention, the authentication data can be acquired via the portable terminal movable to the area outside the vehicle to carry out identity verification. Thus, even if the vehicle is stopped outside the communication range of the management center, the authentication data acquired via the portable terminal may be used to carry out identity verification.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a schematic view showing a vehicle on-board biometric authentication system according to one embodiment of the invention;

FIG. 2 is a block diagram showing the vehicle on-board biometric authentication system according to the embodiment of the invention;

FIG. 3 is a flowchart showing an operation procedure of the vehicle on-board biometric authentication system according to the embodiment of the invention; and

FIG. 4 is a flowchart showing an operation procedure of a vehicle on-board biometric authentication system according to a second embodiment of the invention.

### DETAILED DESCRIPTION OF EMBODIMENTS

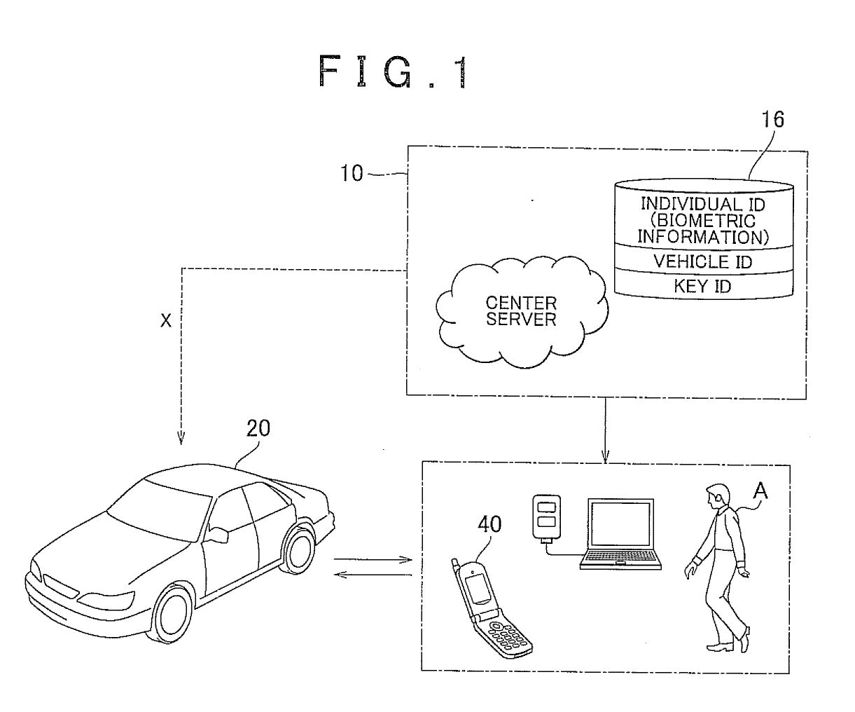

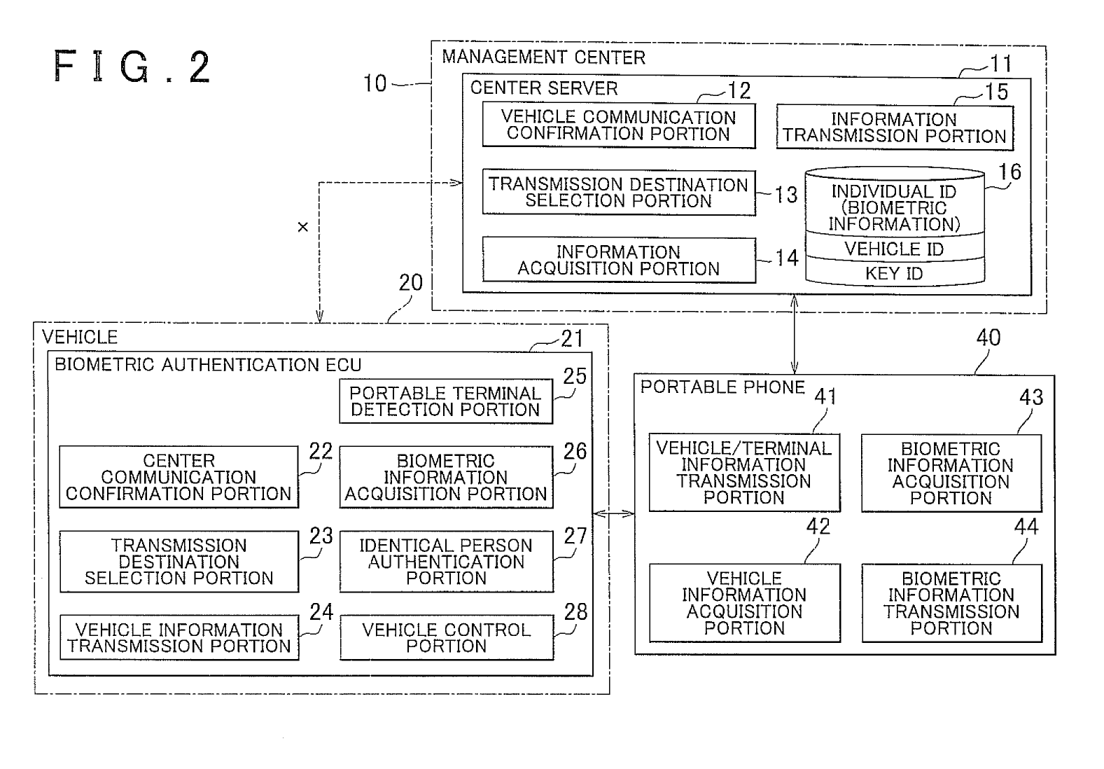

Examples embodiments of a vehicle on-board biometric authentication system according to the invention will be described with reference to the drawings. In the description of the drawings, like symbols denote like or equivalent elements, and the same description is not repeated. FIG. 1 is a schematic view showing the vehicle on-board biometric authentication system according to one embodiment of the invention. FIG. 2 is a block diagram showing the vehicle on-board biometric authentication system according to the embodiment of the invention.

The vehicle on-board biometric authentication system shown in FIG. 1 may be applied to lock/unlock the door of the vehicle 20 and start the engine, and uses biometric information of a user A to verify user A's identity. The vehicle on-board biometric authentication system acquires biometric data from a data management center 10, and collates the biometric data with the biometric information obtained from the user A to verify the person's identity.

Biometric information that may be used to verify a person's identify include face image information or iris information acquired by a camera installed on the vehicle, fingerprint information or vein information acquired by a door handle, walking pattern information acquired by a walking signal detection device, and fingerprint information or vein information acquired by an engine start switch. Information on other biometric characteristics may be acquired to verify identity.

The data management center 10 of this system is provided with a center server 11 in which biometric data are stored. The center server 11 is comprised of a CPU, a ROM and a RAM, an input signal circuit, an output signal circuit, a power supply circuit, and the like. Further, the center server 11 is connected to a communication network to communicate with an on-board device on the vehicle 20 (a biometric authentication ECU 21) and a portable phone 40.

The center server 11 is includes a biometric data storage portion 16. A database (DB) in which biometric data used to verify a person's identity are stored is provided in the authentication data storage portion 16. In the database, a vehicle ID for identifying the vehicle, a key ID for identifying a key (an electronic key) for the vehicle, an individual ID for identifying an individual (the user A), a portable terminal ID for identifying a portable terminal, biometric data of the individual, and the like are registered as authentication data.

It should be noted herein that the vehicle on-board biometric authentication system according to this embodiment of the invention may also transfer biometric data to a portable phone 40 when communication between the data management center 10 and the vehicle 20 is impossible. As shown in FIG. 2, a vehicle communication confirmation portion 12, a transmission destination selection portion 13, an information acquisition portion 14, an information transmission portion 15, and an biometric data storage portion 16 are provided in the center server 11 of the data management center 10.

The vehicle communication confirmation portion 12 determines whether communication with the vehicle 20 is possible, and regularly confirms the state of communication with the vehicle 20. For example, if a response request signal is transmitted from the center server 11 to the biometric authentication ECU 21 of the vehicle 20 and a response signal is returned from the biometric authentication ECU 21, the vehicle communication confirmation portion 12 determines that communication is possible.

The transmission destination selection portion 13 selects the destination of data transmitted in accordance with the state of communication between the data management center 10 and the vehicle 20. For example, if communication between the data management center 10 and the vehicle 20 is impossible, the transmission destination selection portion 13 may change the destination of data transmitted from the vehicle 20 to the portable phone 40.

The information acquisition portion 14 communicates with the portable phone 40 and the vehicle 20 to acquire the vehicle ID from the vehicle 20 and the portable terminal ID (the key ID) output from the portable phone 40.

The information transmission portion 15 transmits to the portable phone 40 (or the vehicle 20) biometric information (authentication data) tied (associated) with the vehicle ID or the portable terminal ID.

The portable phone 40 belongs to the user A, the person whose identity is to be verified. The portable phone 40 includes a call function, a mail transmission/reception function, a network connection function, an imaging function, and the like. In addition, the portable phone 40 is equipped with a CPU that performs calculation processings, a ROM and a RAM that serve as a storage portion, an input signal circuit, an output signal circuit, a power supply circuit, and the like. A vehicle/terminal information transmission portion 41, a vehicle information acquisition portion 42, a biometric information acquisition portion 43, and a biometric information transmission portion 44 are provided in the portable phone 40.

Further, the portable phone 40 communicates with the center server 11 and the vehicle 20. Possible methods of communication between the portable phone 40 and the vehicle 20 are Bluetooth, adhoc communication using infrared rays or the like, body area network, mail attachment, and the like.

The vehicle information acquisition portion 42 receives the vehicle ID output from the vehicle 20. The vehicle/terminal information transmission portion 41 transmits the received vehicle ID and the portable terminal ID (the key ID) for identifying the portable phone 40 to the data management center 10.

The biometric information acquisition portion 43 receives the registered biometric data from the data management center 10. Further, the storage portion of the portable phone stores the registered biometric data acquired by the biometric information acquisition portion 43. The biometric information transmission portion 44 transmits to the vehicle 20 the registered biometric data retrieved from the data management center 10.

The on-board device of the vehicle 20, to which the vehicular biometric authentication system according to this embodiment of the invention is applied, is equipped with an electronic control unit (hereinafter referred to as “a biometric authentication ECU”) 21 that performs control regarding biometric authentication.

The biometric authentication ECU 21 is composed of a CPU, a ROM and a RAM, an input signal circuit, an output signal circuit, a power supply circuit, and the like. A center communication confirmation portion 22, a transmission selection portion 23, a vehicle information transmission portion 24, a portable terminal detection portion 25, a biometric information acquisition portion 26, an identity verification portion 27, and a vehicle control portion 28 are provided in the biometric authentication ECU 21 through the execution of a program stored in the storage portion. Further, the biometric authentication ECU 21 communicates with the center server 11 and the portable phone 40.

The center communication confirmation portion 22 confirms the state of communication with the management center 10 when the engine is turned off. For example, upon receiving from an engine ECU a signal indicating stoppage of the engine, the center communication confirmation portion 22 determines whether communication with the center server 11 is possible.

The transmission destination selection portion 23 selects the transmission destination of data in accordance with the state of communication between the data management center 10 and the vehicle 20. For example, if communication between the data management center 10 and the vehicle 20 is impossible, the transmission destination selection portion 23 change the transmission destination of data from the data management center 10 to the portable phone 40. The vehicle information transmission portion 24 transmits to the portable phone 40 the vehicle ID that identifies the vehicle 20.

The portable terminal detection portion 25 detects the portable phone 40 carried by the user A (the person to be authenticated) of the vehicle 20. Further, the portable terminal detection portion 25 functions as a key detection portion for detecting the key (the key ID) for the vehicle 20.

The biometric information acquisition portion 26 acquires (i.e. retrieves) the registered biometric data output from the data management center 10. The biometric information acquisition portion 26 receives, via the portable phone 40, the registered biometric data from the data management center 10.

The identity verification portion 27 functions as biometric authentication means for comparing the registered biometric data retrieved from the data management center 10 with the sampled biometric information from user A to carry out verify user A's identity. The biometric authentication ECU 21 is electrically connected to a biometric information sampling device that samples the biometric information from the user A, and acquires the biometric information on the user A that has been sampled by the biometric information sampling device.

Suitable biometric information sampling devices include, for example, fingerprint/vein sensors provided on the door handle, fingerprint/vein sensors provided on the engine start switch, walking signal detection sensors provided on a lateral portion of the vehicle to detect a walking pattern of the user A, on-board cameras that detect a face image of the user A and iris information on the user A, and the like.

The identify verification portion 27 performs biometric authentication in accordance with the boarding operation of the user A (the opening/closing of a door, boarding, the turning on of an engine switch, and the like). The identity verification portion 27 compares the biometric information sampled by the biometric information sampling device with the registered biometric data to carry out biometric authentication.

The vehicle control portion 28 performs door lock control, engine start permission control, and the like in accordance with an authentication result obtained by the identity verification portion 27. If the user A is authenticated as a user qualified to drive the vehicle 20, the vehicle control portion 28 unlocks the door lock and permits the start of the engine. For example, the vehicle control portion 28 transmits command signals to a door lock control device and the engine ECU to command them to unlock the door lock and permit the start of the engine respectively.

Further, information on the driver seat position of the user A associated with the portable terminal ID and the like may also stored in the storage portion of the biometric authentication ECU 21. Further, based on the information on the driver seat position, the vehicle control portion 28 transmits a command signal to adjust the seat position.

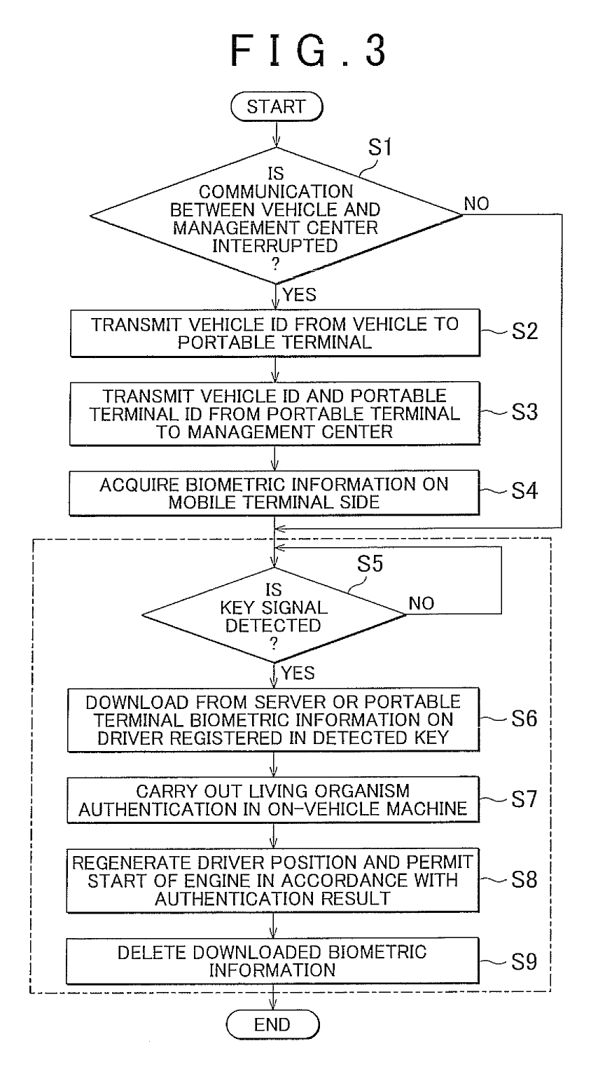

Next, the operation of the vehicular biometric authentication system according to this embodiment of the invention will be described. FIG. 3 is a flowchart showing the processes of the vehicular biometric authentication system according to this embodiment of the invention. It should be noted that steps are abbreviated as S.

First, the state of communication between the vehicle 20 and the data management center 10 is confirmed (S1). The vehicle communication confirmation portion 12 of the center server 11 regularly determines whether communication with the vehicle 20 is possible. The center communication confirmation portion 22 of the biometric authentication ECU 21 determines whether communication with the data management center 10 is possible. If communication between the vehicle 20 and the data management center 10 is not possible, the operation proceeds to S2. If communication with the vehicle 20 is possible, the operation proceeds to S5. For example, if the vehicle 20 is stopped outside the communication range of the data management center 10, the operation proceeds to S2.

In S2, the vehicle ID is transmitted from the vehicle 20 to the portable phone 40. More specifically, the transmission destination selection portion 23 of the biometric authentication ECU 21 changes the transmission destination of data to the portable phone 40, and the vehicle information transmission portion 24 transmits the vehicle ID to the portable phone 40.

Next in S3, the vehicle ID and the portable terminal ID are transmitted from the portable phone 40 to the data management center 10. The portable phone 40 receives the vehicle ID output from the vehicle 20 by means of the vehicle information acquisition portion 42. The vehicle/terminal information transmission portion 41 transmits the portable terminal ID and the received vehicle ID to the data management center 10. The information acquisition portion 14 of the center server 11 acquires the vehicle ID and the portable terminal ID output from the portable phone 40.

Then, the transmission destination selection portion 13 of the center server 11 changes the transmission destination of the registered biometric data to the portable phone 40. The information transmission portion 15 transmits the registered biometric data associated with the vehicle ID and the portable terminal ID, to the portable phone 40. The biometric information acquisition portion 43 of the portable phone 40 receives the authentication data output from the center server 11 (S4). The received registered biometric data are stored into the storage portion of the portable phone 40.

In S5, it is determined whether a key signal is detected. More specifically, the portable terminal detection portion 25 of the biometric authentication ECU 21 determines whether the portable phone 40 of the user A is detected. If the portable terminal ID (key information as an electronic key) of the portable phone 40 is detected, it is determined that the key signal is detected, and the operation proceeds to S6. If the key signal is not detected, the operation returns to S5. When the key signal is once detected, the operation proceeds to S6.

In S6, the registered biometric data of the driver (the user A) registered in the detected key signal are downloaded from the data management center 10 or the portable phone 40. That is, when communication between the management center 10 and the vehicle 20 is possible, the biometric information acquisition portion 26 of the biometric authentication ECU 21 receives, without the intermediary of the portable phone 40, the registered biometric data from the information transmission portion 15 of the center server 11. If communication between the management center 10 and the vehicle 20 is impossible, the biometric information acquisition portion 26 of the biometric authentication ECU 21 acquires the registered biometric data via the portable phone 40.

Then in S7, the biometric authentication ECU 21 of the on-vehicle machine carries out biometric authentication by means of the identity verification portion 27. Subsequently in S8, the vehicle control portion 28 of the biometric authentication ECU 21 transmits a command signal in accordance with an authentication result to unlock the door lock, restore the driver's seat position, and permit the start of the engine.

Subsequently in S9, the biometric authentication ECU 21 deletes the sampled biometric information and the registered biometric data downloaded from the data management center 10. In this case, if the biometric data of the driver is acquired via the portable phone 40 and biometric authentication is carried out in the on-vehicle machine, it is also preferable that a predetermined period of validity be set. In this case, after the predetermined period of validity expires, the sampled biometric information and the biometric data downloaded by the biometric authentication ECU 21 in S9 are deleted.

The vehicular biometric authentication system described above is generally equipped with the portable phone 40 that includes the biometric information acquisition portion 43 for receiving the registered biometric data output from the data management center 10, and the on-board device (the biometric authentication ECU 21) that acquires the registered biometric data via the portable phone 40 and uses the acquired biometric data to carry out identity verification when communication with the data management center 10 is impossible. Therefore, even if the vehicle 20 is stopped outside the communication range of the data management center 10, the registered biometric data output from the management center 10 may be acquired via the portable phone 40. Thus, in the biometric authentication ECU 21 of the on-board device, the registered biometric data acquired via the portable phone 40 is utilized to carry out identity verification.

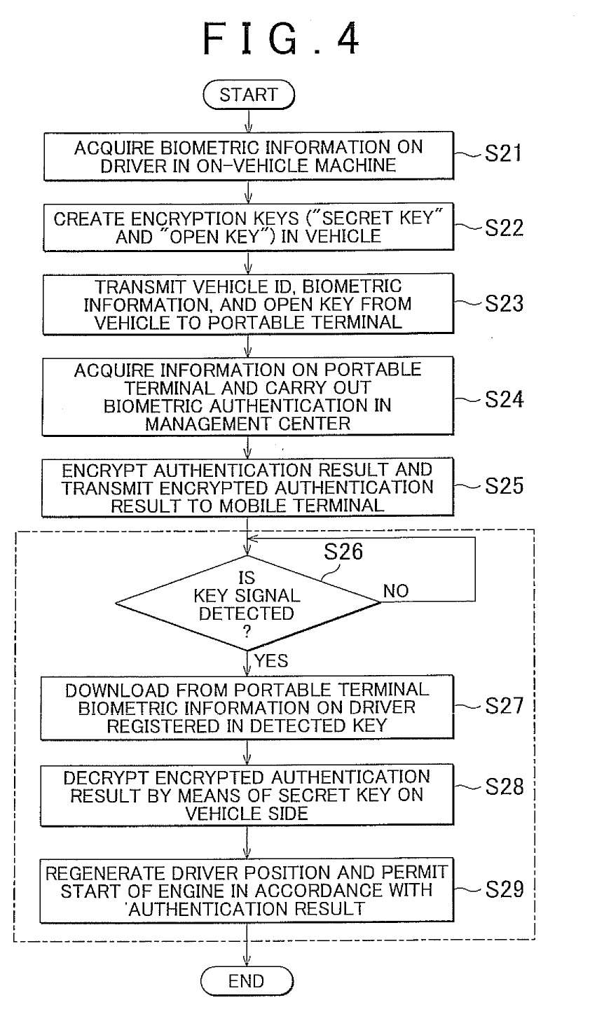

Next, the operation of a vehicle on-board biometric authentication system according to a second embodiment of the invention will be described with reference to FIG. 4. It should be noted that the system according to the second embodiment of the invention is identical in configuration to the system shown in FIG. 2.

In the vehicle on-board biometric authentication system according to the second embodiment of the invention, when the driver exits the vehicle, a state of communication between the data management center 10 and the vehicle 20 is confirmed. If communication with the data management center 10 is not possible, biometric information and an encryption key (key information including a code) are transmitted to the portable phone 40.

Within the communication range of the data management center 10, various information is transmitted from the portable phone 40 to the data management center 10. The information thus transmitted include the sampled biometric information from the driver, the vehicle ID of the vehicle 20, the portable terminal ID of the portable phone, the key ID, and the like. The data management center 10 receives the information output from the portable phone 40, and collates the received information with the registered biometric data to carry out identity verification.

In the data management center 10, the verification result is encrypted. The portable phone 40 then downloads the encrypted authentication result. The next time that the driver gets on the vehicle, the encrypted verification result is transmitted from the portable phone 40 to the vehicle 20. In the biometric authentication ECU 21 of the vehicle 20, the authentication result is decrypted to carry out identity verification.

The following description will be given with reference to the flowchart of FIG. 4. The biometric information of the driver is sampled by the biometric information acquisition portion 26 of the biometric authentication ECU 21 (S21). Then in the vehicle 20, encryption keys (“a secret key” and “an open key”) are created (S22). The biometric authentication ECU 21 of the vehicle 20 creates secret key information and open key information as the encryption keys (information).

Then, the vehicle ID, the sampled biometric information, and the open key information are transmitted from the vehicle 20 to the portable phone 40 (S23). In this case, the vehicle information transmission portion 24 of the biometric authentication ECU 21 transmits the vehicle ID, the sampled biometric information, and the open key information to the portable phone 40.

Subsequently, information on the portable phone 40 is acquired, and biometric authentication is carried out by the data management center 10 (S24). More specifically, the vehicle information acquisition portion 42 of the portable phone 40 receives the vehicle ID, the sampled biometric information, and the open key information that have been output from the biometric authentication ECU 21. The vehicle/terminal information transmission portion 41 transmits the portable terminal ID, the vehicle ID, the sampled biometric information, and the open key information to the management center 10. The management center 10 receives the portable terminal ID, the vehicle ID, the biometric information, and the open key information, and compares the received information with the registered biometric data stored in the authentication data storage portion 16 to carry out identity verification.

Then, the center server 11 encrypts an authentication result and transmits the encrypted authentication result to the portable phone 40 (S25). In the portable phone 40, the encrypted authentication result is stored into the storage portion.

Processes performed in S26 to S29, which will be described subsequently, are directed to identity verification that is performed by the on-board device the next time that the driver gets on the vehicle. First, in S26, it is determined whether a key signal is detected. More specifically, the portable terminal detection portion 25 of the biometric authentication ECU 21 determines whether the portable phone 40 of user A is detected. If the portable terminal ID (key information as the electronic key) of the portable phone 40 is detected, it is determined that the key signal is detected, and the operation proceeds to S27. If the key signal is not detected, the operation returns to S26. When the key signal is once detected, the operation proceeds to S27.

In S27, the driver's registered biometric data embedded in the detected key signal are downloaded from the portable phone 40. That is, the biometric information acquisition portion 26 of the biometric authentication ECU 21 acquires the registered biometric data via the portable phone 40.

In S28, decryption is carried out on the vehicle 20 side by the secret key. More specifically, the biometric authentication ECU 21 decrypts the information on the encrypted authentication result using the secret key information, to carry out identity verification.

Then in S29, control processes such as the release of the door lock, the regeneration of the driver position, the permission to start the engine, and the like are performed in accordance with the deciphered authentication result.

In the vehicular biometric authentication system according to the second embodiment of the invention as described above as well, the data (authentication data) on the encrypted authentication result can be acquired via the portable phone 40. Therefore, biometric authentication may be carried out even if the vehicle 20 is stopped outside the communication range of the data management center 10.

The invention has been described above concretely based on the embodiments thereof. However, the invention should not be limited to the foregoing embodiments thereof. Although the portable terminal is described as the portable phone 40 in each of the foregoing embodiments of the invention, another terminal capable of establishing communication or an external terminal movable to an area outside the vehicle may be employed as the portable terminal. Further, a key endowed with a communication function or the like may also be employed as the portable terminal.

In each of the foregoing embodiments of the invention, the vehicle communication confirmation portion 12 of the center server 11 regularly determines whether communication with the vehicle 20 is possible. However, it is also appropriate to adopt a configuration in which authentication data are transmitted to the portable terminal regardless of whether communication between the center server 11 and the vehicle 20 is possible. In the case of this configuration, the center server 11 is not required to regularly confirm the state of communication with the vehicle 20. Therefore, the system may be simplified.

While the invention has been described with reference to the example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A vehicle on-board biometric authentication system that compares biometric data that has been registered with a data management center, with biometric information obtained from a person to verify the person's identity, comprising:
a portable terminal equipped with a receiver that receives the biometric data output from the data management center; and
an on-board device that acquires the biometric data from the data management center or via the portable terminal and uses the acquired biometric data to verify the person's identity.

2. The vehicle on-board biometric authentication system according to claim 1, wherein
the on-board device acquires the biometric data via the portable terminal and uses the acquired biometric data to verify the person's identity when the portable terminal moves during stoppage of a vehicle.

3. The vehicle on-board biometric authentication system according to claim 1, wherein
the on-board device acquires the biometric data via the portable terminal and uses the acquired authentication data to verify the person's identity when communication between the on-vehicle machine and the management center is impossible.

4. The vehicle on-board biometric authentication system according to claim 3, wherein
the acquired biometric data are deleted from the on-board device after a predetermined period of time has elapsed.
